(19) United States
(12) Patent Application Publication
(10) Pub. No.: US 2012/0108180 A1
(43) Pub. Date: May 3, 2012

(54) RADIO BASE STATION AND COMMUNICATION CONTROL METHOD

(75) Inventor: Takafumi Shibuya, Kanagawa (JP)

(73) Assignee: KYOCERA CORPORATION, Kyoto (JP)

(21) Appl. No.: 13/382,792

(22) PCT Filed: Jul. 8, 2010
(86) PCT No.: PCT/JP2010/061631

§ 371 Date: Jan. 6, 2012

(30) Foreign Application Priority Data
Jul. 8, 2009 (JP) 2009-161854

(51) Int. Cl. H04W 24/00

(52) U.S. Cl. 455/67.13

(57) ABSTRACT

For each resource block assigned to radio terminal (2A), radio base station (1A) measures the amount of interference the resource blocks receive from the communication from radio terminal (2B) to radio base station (1B) and the communication from radio terminal (2C) to radio base station (1C). Further, radio base station (1A) sends a command to lower the transmission power when the amount of interference continuously exceeds a threshold value for the duration of a first time period or more, and sends the amount of interference when the amount of interference continuously exceeds a threshold value for the duration of a second time period or more (second time period<first time period).

### TECHNICAL FIELD

The present invention relates to a radio base station that performs communication by assigning a radio resource to a radio terminal, and relates also to a communication control method in the radio base station.

### BACKGROUND ART

In a radio communication system in which communication is performed between a radio base station and a radio terminal, a radio resource assigned to the radio terminal by the radio base station experiences interference resulting from communication between other adjacent radio base station and other radio terminal. This interference restricts the throughput and capacity of the communication between the radio base station and the radio terminal.

In a radio communication system that adopts LTE (Long Term Evolution), a standard designed in 3GPP (Third Generation Partnership Project), a radio base station assigns the optimum radio resource to a radio terminal by using a radio resource assignment method called scheduling (for example, see Patent Document 1). As a result, the throughput and capacity of the communication between the radio base station and the radio terminal improve.

Scheduling is performed based on the communication quality of the radio resource, the amount of interference received by the radio resource and results from communication between other radio base station and other radio terminal, the channel quality information from the radio terminal, etc. Of these, the amount of interference is measured in each radio base station for each subframe, which is a radio resource, or for each slot, and is transmitted via a backbone network, which is a wired line provided among the radio base stations. Thus, the amount of interference is shared among the radio base stations. When each radio base station receives the amount of interference arising in the radio resource of the other radio base station resulting from communication between the local radio base station and the radio terminal, each radio base station performs communication control relating to the radio resource, such as change in the assignment of the radio resource and control of the transmission power in the communication using the radio resource based on the amount of interference.

### PRIOR ART DOCUMENT

### Patent Document

Patent Document 1: Japanese Unexamined Patent Application Publication No. 2002-247626.

### SUMMARY OF THE INVENTION

However, because the time length of a subframe is 1 [ms] and the time length of a slot is 0.5 [ms], if the amount of interference is transmitted for each subframe or for each slot, then the backbone network receives a huge load. Such an increase in the load causes information to be lost or delayed, and may become a hindrance in optimum communication control relating to the radio resource.

To deal with the above problem, there have been proposed a method in which a radio station transmits the amount of interference of a subframe or of a plurality of slots in a predetermined time period, and a method in which the radio base station calculates the average value of the amount of interference of a plurality of subframes or a plurality of slots, and then transmitting the average value. However, in such methods, the peak of the amount of interference becomes unclear and it becomes difficult for the radio base station at the receiving side to perform appropriate communication control relating to the radio resource in accordance with the peak of the amount of interference.

In view of the foregoing problems, an object of the present invention is to provide a radio base station and a communication control method in which appropriate communication control relating to a radio resource is enabled while reducing the communication load between radio base stations.

To solve the above problem, the present invention has following features. A first feature of the present invention is summarized as a radio base station (radio base station 1A) which performs communication by assigning a radio resource to a radio terminal (radio terminal 2A), comprising: a measurement unit (measurement unit 152) configured to measure, for each radio resource, an amount of interference that the radio resource received from communication between other radio base station and other radio terminal; and a transmission unit (transmission processing unit 154) configured to transmit information relating to the amount of interference to other radio base station (radio base station 1B, 1C) when the amount of interference measured by the measurement unit exceeds a predetermined threshold value.

Such a radio base station measures for each radio resource the amount of interference received by the radio resource and results from communication between other radio base station and other radio terminals, but rather than transmitting information about the entire amount of interference to the other radio base stations, it transmits information about the amount of interference to the other radio base stations only when a predetermined threshold value is exceeded.

Thus, the communication load of the lines among the radio base stations is reduced. Furthermore, communication control relating to the radio resources corresponding to the amount of interference that has exceeded the predetermined threshold value, in other words, the amount of interference that has a large effect on communication using radio resources, can be performed appropriately.

A second feature of the present invention according to the first feature is summarized as that the transmission unit suspends the transmission of information relating to the amount of interference to the other radio base station when the amount of interference measured by the measurement unit is equal to or less that the predetermined threshold value.

A third feature of the present invention according to the first feature or the second feature is summarized as that the radio resource is defined based on frequency and time, and the transmission unit transmits information for instructing to decrease the transmission power, to the other radio base station, when the amount of interference received by the radio resource of the predetermined frequency band exceeds the predetermined threshold value for a first time period or longer.

A fourth feature of the present invention according to any one of the first to third features is summarized as that the radio resource is defined based on frequency and time, and the transmission unit transmits the amount of interference to the other radio base station, when the amount of interference received by the radio resource of the predetermined frequency band exceeds the predetermined threshold value for a second time period or longer.

A fifth feature of the present invention is summarized as that the transmission unit transmits suspension notification information indicating suspension of the transmission of the information relating to the amount of interference to the other radio base station in a predetermined period.

A sixth feature of the present invention is summarized as that the transmission unit transmits resumption notification information indicating resumption of the transmission of the information relating to the amount of interference to the other radio base station in a predetermined period, after transmitting the suspension notification information.

A seventh feature of the present invention is summarized as a communication control method of a radio base station in which communication is performed by assigning a radio resource to a radio terminal, comprising: a step in which the radio base station measures for each radio resource an amount of interference that the radio resource receives from communication between other radio base station and other radio terminal; and a step in which the radio base station transmits information relating to the amount of interference to other radio base station when the measured amount of interference exceeds a predetermined threshold value.

According to the present invention, appropriate communication control relating to the radio resource can be performed while reducing the communication load among the radio base stations.

### BRIEF DESCRIPTION OF THE DRAWINGS

FIG. 1 is a diagram showing the entire schematic configuration of a radio communication system according to an embodiment of the present invention.

FIG. 2 is a diagram showing a configuration of a radio resource according to the embodiment of the present invention.

FIG. 3 is a diagram showing a schematic configuration of a radio base station according to the embodiment of the present invention.

FIG. 4 is a flowchart showing an operation of the radio base station according to the embodiment of the present invention.

FIG. 5 is a flowchart showing another operation of the radio base station according to the embodiment of the present invention.

FIG. 6 is a diagram showing a first example of transmitting a conventional amount of interference.

FIG. 7 is a diagram showing a second example of transmitting the conventional amount of interference.

FIG. 8 is a diagram showing an example of transmitting an amount of interference and a transmission power decrease instruction according to the embodiment of the present invention.

### BEST MODES FOR CARRYING OUT THE INVENTION

Next, an embodiment of the present invention will be described with reference to the drawings. More specifically, (1) Configuration of Radio Communication System, (2) Operation of Radio Base Station, (3) Operation and Effect, and (4) Other Embodiments will be described. It is to be noted that the same or similar reference numerals are applied to the same or similar parts through the drawings in the following embodiments.

### (1) Configuration of Radio Communication System

First of all, a configuration of a radio communication system according to an embodiment of the present invention is explained in the order of (1.1) Entire Schematic Configuration of Radio Communication System and (1.2) Configuration of Radio Base Station.

### (1.1) Entire Schematic Configuration of Radio Communication System

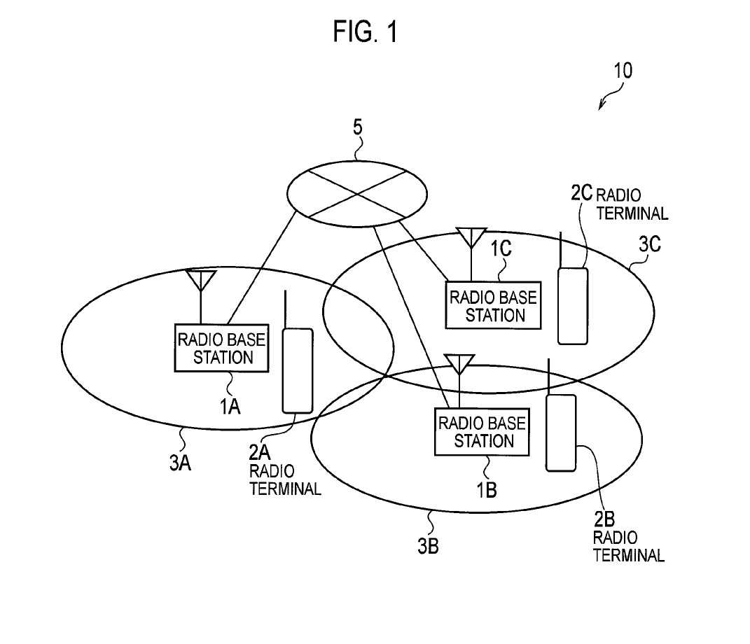

FIG. 1 is a diagram showing the entire schematic configuration of a radio communication system 10 according to an embodiment of the present invention.

As shown in FIG. 1, the radio communication system 10 includes a radio base station 1A, a radio base station 1B, a radio base station 1C, a radio terminal 2A, a radio terminal 2B, a radio terminal 2C, and a backbone network 5. The radio communication system 10 has a configuration based on LTE, a standard designed in 3GPP. In FIG. 1, the radio terminal 2A exists in a cell 3A provided by the radio base station 1A. Furthermore, the radio terminal 2B exists in a cell 3B provided by the radio base station 1B, and the radio terminal 2C exists in a cell 3C provided by the radio base station 1C.

When each of the radio terminal 2A, the radio terminal 2B, and the radio terminal 2C is turned ON or handed over, it compares the communication quality of the reference signals and pilot signals transmitted by the radio base station 1A through the radio base station 1C, and then transmits the location registration request information for requesting location registration to the radio base station transmitting the reference signal and the like with the highest communication quality. When the radio base stations 1A through 1C receive the location registration request information from the radio terminals, they perform location registration of the radio terminals, and at the same time, assign a radio resource to the radio terminals. Thus, communications between the radio terminals and the radio base stations using the radio resources are enabled.

In an example shown in FIG. 1, the radio terminal 2A exists in the cell 3A. Therefore, in the radio terminal 2A, normally, the communication quality of the reference signal and the like from the radio base station 1A is the highest. In such a case, the radio terminal 2A transmits the location registration request information to the radio base station 1A. When the radio base station 1A receives the location registration request information from the radio terminal 2A, it performs location registration of the radio terminal 2A, and at the same time, assigns a radio resource to the radio terminal 2A. As a result of such a process, the communication between the radio base station 1A and the radio terminal 2A is enabled.

Furthermore, the radio terminal 2B exists in the cell 3B. Therefore, in the radio terminal 2B, normally, the communication quality of the reference signal and the like from the radio base station 1B is the highest. In such a case, the radio terminal 2B transmits the location registration request information to the radio base station 1B. When the radio base station 1B receives the location registration request information from the radio terminal 2B, it performs location registration of the radio terminal 2B, and at the same time, assigns a radio resource to the radio terminal 2B. As a result of such a process, the communication between the radio base station 1B and the radio terminal 2B is enabled.

Furthermore, the radio terminal 2C exists in the cell 3C. In such a case, in the radio terminal 2C, normally, the communication quality of the reference signal and the like from the radio base station 1C is the highest. Therefore, the radio terminal 2C transmits the location registration request information to the radio base station 1C. When the radio base station 1C receives the location registration request information from the radio terminal 2C, it performs location registration of the radio terminal 2C, and at the same time, assigns a radio resource to the radio terminal 2C. As a result of such a process, the radio terminal 2C connects to the radio base station 1C. As a result of such a process, the communication between the radio base station 1C and the radio terminal 2C is enabled.

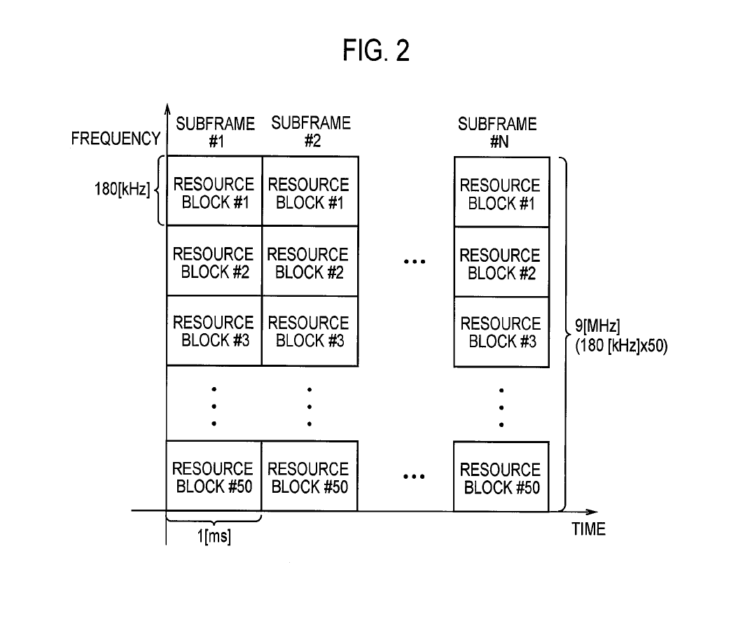

FIG. 2 is a diagram showing a configuration of a radio resource which a radio base station can assign to a radio terminal. As shown in FIG. 2, a radio resource is divided into subframes having a time length of 1 [ms]. Each subframe has a band of 9 [MHz] as a system band. Each subframe is divided into 50 resource blocks having a band of 180 [kHz]. A resource block is the minimum assigned unit of a radio resource in a radio terminal. The radio base station assigns a single or a plurality of resource blocks to a radio terminal. Note that each subframe has a system band of 10 [MHz], but the actually used band is 9 [MHz]. The remaining band is used for the guard bands. The band for the guard bands is not shown in FIG. 2.

### (1.2) Configuration of Radio Base Station

Subsequently, a configuration of the radio base station 1A is explained. Note that because the configurations of the radio base station 1B and the radio base station 1C are same as that of the radio base station 1A, the explanation relating to those of the radio base station 1B and the radio base station 1C is omitted.

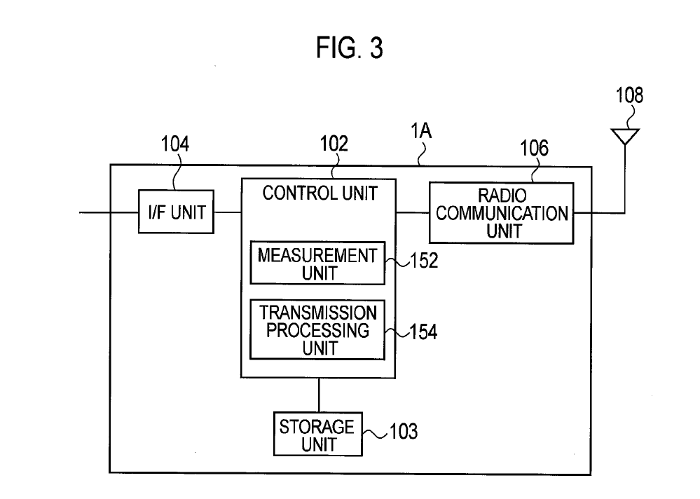

FIG. 3 is a diagram showing a schematic configuration of the radio base station 1A. As shown in FIG. 3, the radio base station 1A includes a control unit 102, a storage unit 103, an I/F unit 104, a radio communication unit 106, and an antenna 108.

The control unit 102 is configured from a CPU, for example, and controls various functions of the radio base station 1A. The storage unit 103 is configured from a memory, for example, and stores various types of information used for performing control in the radio base station 1A.

The I/F unit 104 is connected to a backbone network 5. The radio communication unit 106 includes an RF circuit and a baseband circuit, for example, performs modulation and demodulation, and encoding and decoding, and transmits and receives radio signals via the antenna 108. Furthermore, the radio communication unit 106 transmits reference signals and the like via the antenna 108.

The control unit 102 includes a measurement unit 152 and a transmission processing unit 154.

The measurement unit 152 measures for each resource block assigned to the radio terminal 2A the amount of interference that the resource block receives as a result of communicating from the radio terminal 2B to the radio base station 1B, and from the radio terminal 2C to the radio base station 1C.

Specifically, the radio terminal 2A transmits a radio signal to the radio base station 1A using the assigned resource block. When the radio communication unit 106 receives the radio signal from the radio terminal 2A via the antenna 108, the measurement unit 152 measures the reciprocal of SNR (Signal to Noise Ratio) and the reciprocal of RSSI (Received Signal Strength Indicator) of the radio signal as the amount of interference.

Furthermore, when the radio communication unit 106 acquires the reception data by performing demodulation and decoding of the radio signal, and outputs the reception data to the measurement unit 152, the measurement unit 152 measures the BER (Bit Error Rate), the PER (Packet Error Rate), and the FER (Frame Error rate) of the reception data as the amount of interference. Note that the measurement unit 152 need not measure all of the reciprocal of the SNR, the reciprocal of the RSSI, the BER, the PER, and the FER, and can measure at least one as the amount of interference. The measured amount of interference is stored in the storage unit 103 along with the information of the frequency band of the corresponding resource block.

### (First Process)

After measuring the amount of interference, the following first process is performed. Based on the amount of interference measured by the measurement unit 152, the transmission processing unit 154 determines whether or not the amount of interference relating to the resource blocks of the predetermined frequency band continuously exceeds the predetermined threshold value for a first time period or longer. Here, the predetermined frequency band indicates each of the frequency band of the resource block assigned to the radio terminal 2A. Specifically, the following process is performed.

The threshold value corresponding to each amount of interference of the reciprocal of the SNR, the reciprocal of the RSSI, the BER, the PER, and the FER is stored in the storage unit 103. The transmission processing unit 154 reads the threshold value corresponding to an amount of interference of the same type as the amount of interference measured by the measurement unit 152 and stored in the storage unit 103 from the storage unit 103.

Additionally, of the amounts of interference stored in the storage unit 103, the transmission processing unit 154 reads the amount of interference measured within the nearest first time period. Subsequently, the transmission processing unit 154 determines whether or not all the amounts of interference relating to the resource blocks of the predetermined frequency band that has been read have exceeded the threshold value.

When the amount of interference relating to the resource blocks of the predetermined frequency band measured by the measurement unit 152 continuously exceeds the predetermined threshold value for the first time period or longer, the transmission processing unit 154 creates the information for instructing the decrease of the transmission power (transmission power decrease instruction information). Additionally, the transmission processing unit 154 transmits the transmission power decrease instruction information to the radio base station (the radio base station 1B or the radio base station 1C) that performs the communication acting as the cause of interference with a radio terminal via the I/F unit 104 and the backbone network 5.

Specifically, when the radio communication unit 106 receives a radio signal of a control channel from the radio terminal 2B or the radio terminal 2C that performs communication with the radio base station 1B or the radio base station 1C via the antenna 108, the transmission processing unit 154 acquires the ID of the transmission-source radio terminal 2B or radio terminal 2C included in the radio signal, and the ID of the destination radio base station 1B or radio base station 1C. Subsequently, the transmission processing unit 154 creates the transmission power decrease instruction information including the acquired ID of the radio terminal 2B or the radio terminal 2C. Additionally, the transmission processing unit 154 sets the acquired ID of the radio base station 1B or the radio base station 1C as the destination of the transmission power decrease instruction information, and transmits the transmission power decrease instruction information.

When the radio base station 1B or the radio base station 1C receives the transmission power decrease instruction information, it extracts the ID of the radio terminal included in the transmission power decrease instruction. Additionally, the radio base station 1B or the radio base station 1C transmits the transmission power decrease instruction information to the radio terminal corresponding to the extracted ID. The radio terminal that receives the transmission power decrease instruction information reduces the transmission power of the radio signal transmitted to the radio base station 1B or the radio base station 1C in accordance with the transmission power decrease instruction information.

Furthermore, the transmission processing unit 154 determines whether or not the amount of interference relating to the resource blocks of the predetermined frequency band measured by the measurement unit 152 continuously exceeds the predetermined threshold value for a second time period or longer. Here, the second time period is shorter than the aforementioned first time period, for example, it is 2 [ms], which is the time period corresponding to two subframes. Specifically, the following process is performed.

Similar to the above, the transmission processing unit 154 reads the threshold value corresponding to an amount of interference of the same type as the amount of interference measured by the measurement unit 152 and stored in the storage unit 103 from the storage unit 103.

Additionally, of the amounts of interference stored in the storage unit 103, the transmission processing unit 154 reads the amount of interference measured within the nearest second time period. Subsequently, the transmission processing unit 154 determines whether or not all the amounts of interference relating to the resource blocks of the predetermined frequency band that has been read have exceeded the threshold value.

When the amount of interference relating to the resource blocks of the predetermined frequency band measured by the measurement unit 152 continuously exceeds the predetermined threshold value for the second time period or longer, the transmission processing unit 154 transmits the information about the amount of interference that exceeds the threshold value (interference amount information) to the radio base station (the radio base station 1B or the radio base station 1C) that performs the communication acting as the cause of interference with a radio terminal via the I/F unit 104 and the backbone network 5.

Specifically, similar to above, when the radio communication unit 106 receives a radio signal of a control channel from the radio terminal 2B or the radio terminal 2C that performs communication with the radio base station 1B or the radio base station 1C via the antenna 108, the transmission processing unit 154 acquires the ID of the transmission-source radio terminal 2B or radio terminal 2C included in the radio signal, and the ID of the destination radio base station 1B or radio base station 1C. Subsequently, the transmission processing unit 154 appends the acquired ID of the radio terminal 2B or the radio terminal 2C to the interference amount information that exceeds the threshold value. Additionally, the transmission processing unit 154 sets the acquired ID of the radio base station 1B or the radio base station 1C as the destination of the interference amount information, and transmits the interference amount information.

Upon receipt of the interference amount information, the radio base station 1B or the radio base station 1C performs control based on the interference amount information as needed. For example, the radio base station 1B or the radio base station 1C acquires the ID of the radio terminal appended to the interference amount information. Additionally, the radio base station 1B or the radio base station 1C transmits the transmission power decrease instruction information to the radio terminal corresponding to the acquired ID. The radio terminal that receives the transmission power decrease instruction information reduces the transmission power of the radio signal transmitted to the radio base station 1B or the radio base station 1C in accordance with the transmission power decrease instruction information.

Note that, for example, when the reception power of the radio signal from the radio terminal is low in the radio base station 1B or the radio base station 1C, and the transmission power of the radio terminal is reduced further, there is no need of transmitting the transmission power decrease instruction to the radio terminal even when the radio base station 1B or the radio base station 1C receive the interference amount information in cases such as when the reception of the radio signal from the radio terminal becomes difficult.

### (Second Process)

When the transmission power decrease instruction information and the interference amount information are transmitted in a predetermined period, the following second process is executed.

The transmission processing unit 154 determines whether or not the condition for suspending the transmission of the transmission power decrease instruction information and the interference amount information in a predetermined period is satisfied. For example, the transmission processing unit 154 measures the traffic amount of the backbone network 5 via the I/F unit 104. Additionally, when the measured traffic amount is the predetermined amount or more, the transmission processing unit 154 determines that the load on the backbone network 5 is high, and the condition for suspending the transmission of the transmission power decrease instruction information and the interference amount information in a predetermined period is satisfied. Furthermore, the transmission processing unit 154 measures the time from the transmission of a ping packet to the radio base station 1B and the radio base station 1C up to the reception of a response packet from the radio base station 1B and the radio base station 1C by the I/F unit 104 via the backbone network 5. Additionally, when the measured time is the predetermined time or longer, the transmission processing unit 154 determines that the load on the backbone network 5 is high, and the condition for suspending the transmission of the transmission power decrease instruction information and the interference amount information in a predetermined period is satisfied.

When the condition for suspending the transmission of the transmission power decrease instruction information and the interference amount information in a predetermined period is satisfied, the transmission processing unit 154 transmits the suspension notification information to the radio base station 1B and the radio base station 1C via the I/F unit 104 and the backbone network 5. The suspension notification information indicates suspension of the transmission of the transmission power decrease instruction information and the interference amount information in a predetermined period.

After transmitting the suspension notification information, the aforementioned first process (hereinafter, appropriately called the non-periodic transmission control) is performed. Even during the time the first process is performed, the transmission processing unit 154 determines whether or not the condition for suspending the transmission of the transmission power decrease instruction information and the interference amount information in a predetermined period is satisfied. When the condition for suspending the transmission of the transmission power decrease instruction information and the interference amount information in a predetermined period is satisfied, the first process continues.

On the other hand, when the condition for suspending the transmission of the transmission power decrease instruction information and the interference amount information in a predetermined period is not satisfied, the transmission processing unit 154 transmits the resumption notification information to the radio base station 1B and the radio base station 1C via the I/F unit 104 and the backbone network 5. The resumption notification information indicates resumption of the transmission of the transmission power decrease instruction information and the interference amount information in a predetermined period.

After transmitting the resumption notification information, the aforementioned first process is suspended and the process for transmitting the transmission power decrease instruction information and interference amount information in a predetermined period is resumed.

### (2) Operation of Radio Base Station

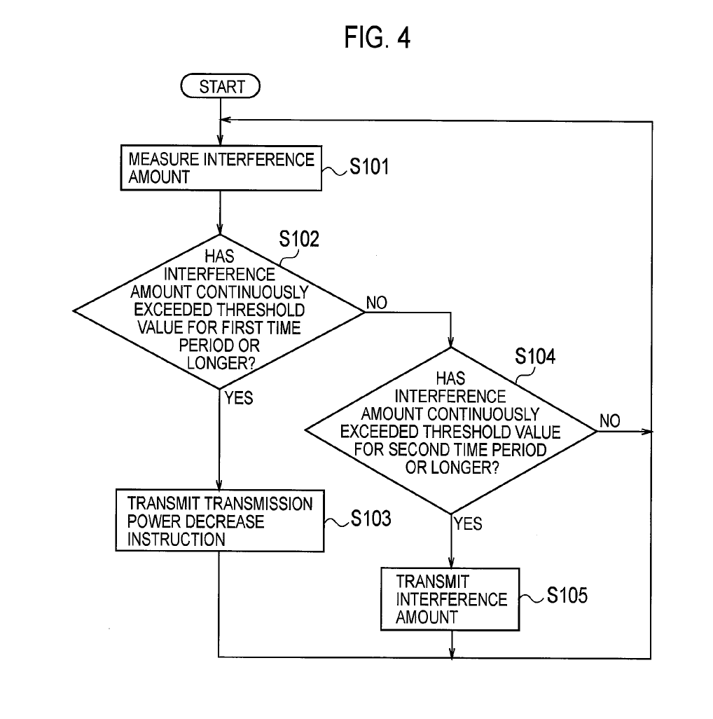

Subsequently, an operation of the radio base station 1A is explained. FIG. 4 is a flowchart showing an operation of the radio base station 1A.

In step S101, the radio base station 1A measures for each resource block assigned to the radio terminal 2A the amount of interference that the resource block receives as a result of communicating from the radio terminal 2B to the radio base station 1B, and from the radio terminal 2C to the radio base station 1C.

In step S102, the radio base station 1A determines whether or not the measured amount of interference relating to the resource blocks of the predetermined frequency band continuously exceeds the predetermined threshold value for the first time period or longer.

When the measured amount of interference relating to the resource blocks of the predetermined frequency band continuously exceeds the predetermined threshold value for the first time period or longer, then in step S103, the radio base station 1A transmits the transmission power decrease instruction information to the radio base station 1B or the radio base station 1C which is the radio base station performing the communication acting as the cause of interference with a radio terminal.

On the other hand, when it is determined in step S102 that the measured amount of interference relating to the resource blocks of the predetermined frequency band does not continuously exceed the predetermined threshold value for the first time period or longer, then in step S104, the radio base station 1A determines whether or not the measured amount of interference relating to the resource blocks of the predetermined frequency band continuously exceeds the predetermined threshold value for the second time period or longer.

When the measured amount of interference relating to the resource blocks of the predetermined frequency band continuously exceeds the predetermined threshold value for the second time period or longer, then in step S105, the radio base station 1A transmits the interference amount information to the radio base station 1B or the radio base station 1C which is the radio base station performing the communication acting as the cause of interference with a radio terminal.

On the other hand, when it is determined in step S104 that the measured amount of interference relating to the resource blocks of the predetermined frequency band does not continuously exceed the predetermined threshold value for the second time period or longer, the operation for measuring the interference amount in step S101 and thereafter is repeated again.

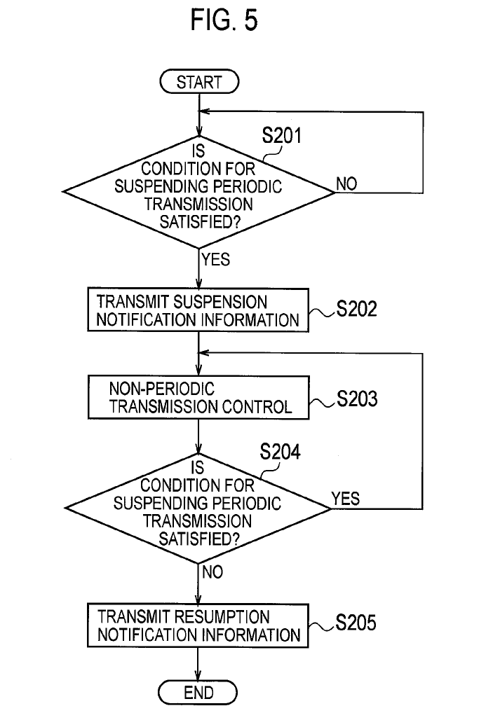

FIG. 5 is a flowchart showing another operation of the radio base station 1A. Note that in the initial state, the transmission power decrease instruction information and the interference amount information are transmitted in a predetermined period.

In step S201, the radio base station 1A determines whether or not the condition for suspending the transmission of the transmission power decrease instruction information and the interference amount information in a predetermined period is satisfied.

When the condition for suspending the transmission of the transmission power decrease instruction information and the interference amount information in a predetermined period is satisfied, then in step S202, the radio base station 1A transmits the suspension notification information to the radio base station 1B and the radio base station 1C.

Following this, in step S203, the radio base station 1A performs non-periodic transmission control. Here, the non-periodic transmission control is an operation shown in FIG. 4.

In step S204, the radio base station 1A determines whether or not the condition for suspending the transmission of the transmission power decrease instruction information and the interference amount information in a predetermined period is satisfied. When the condition for suspending the transmission of the transmission power decrease instruction information and the interference amount information in a predetermined period is satisfied, the non-periodic transmission control of step S203 is continued.

On the other hand, when the condition for suspending the transmission of the transmission power decrease instruction information and the interference amount information in a predetermined period is not satisfied, the radio base station 1A transmits the resumption notification information to the radio base station 1B and the radio base station 1C.

### (3) Operation and Effect

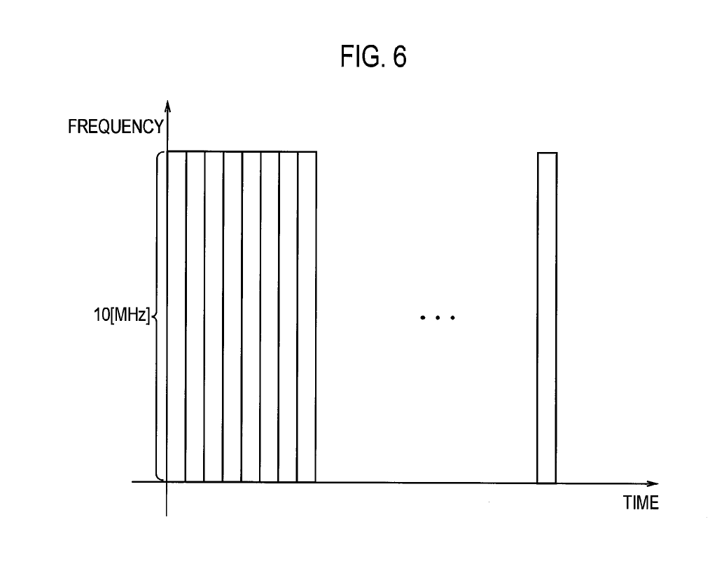

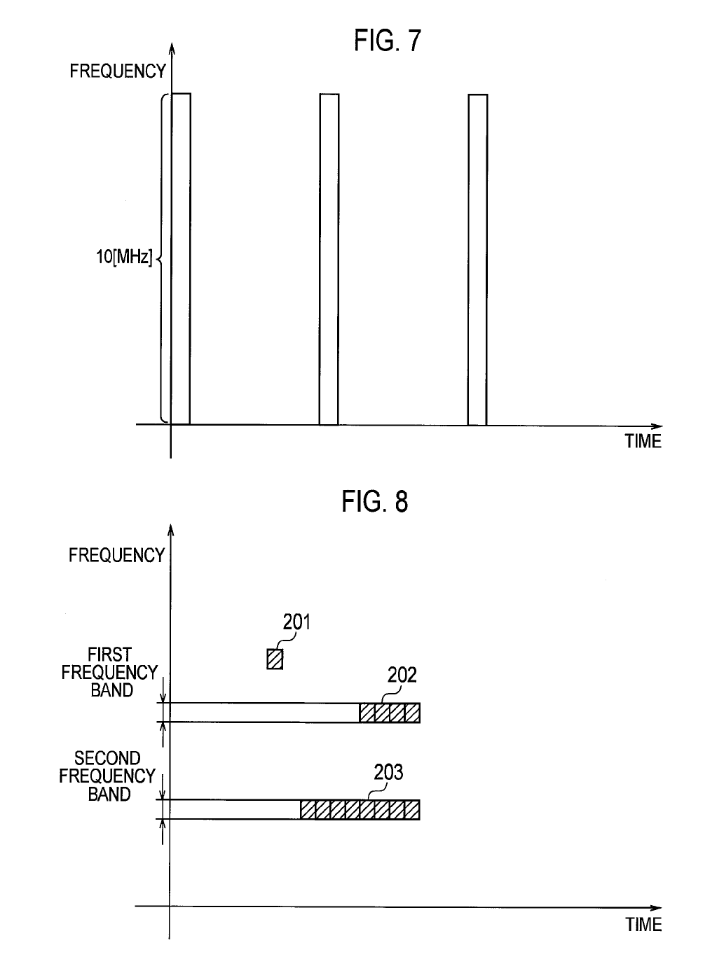

Conventionally, as shown in FIG. 6, because a radio base station transmitted the interference amount information relating to all subframes, the load on the backbone network increased. Furthermore, conventionally, in order to reduce the load on the backbone network, as shown in FIG. 7, if the radio base station would transmit the interference amount information of the subframes in a predetermined time period, and transmit the average value of the amount of interference of a plurality of subframes, the peak of the amount of interference would become unclear, and it would become difficult for the radio base station at the receiving side to perform appropriate communication control relating to the radio resource in accordance with the peak of the amount of interference.

In contrast, in the present embodiment, the radio base station 1A measures for each resource block assigned to the radio terminal 2A the amount of interference that the resource block receives as a result of communicating from the radio terminal 2B to the radio base station 1B, and from the radio terminal 2C to the radio base station 1C. In such a case, rather than transmitting information about all the amounts of interference to the radio base station 1B or the radio base station 1C, the radio base station 1A transmits the transmission power decrease instruction information only when the amount of interference continuously exceeds the threshold value for the first time period or longer, and transmits the interference amount information only when the interference amount information continuously exceeds the threshold value for the second time period (however, the second time period<the first time period) or longer.

Therefore, the communication load on the backbone network 5 that connects among the radio base stations is reduced. Furthermore, appropriate communication control can be performed relating to the resource blocks corresponding to the peak of the amount of interference that has exceeded the predetermined threshold value, in other words, the amount of interference that has a large effect on communication using resource blocks.

For example, the resource blocks for which the amount of interference has exceeded the threshold value are shown by the hashed parts 201, 202, and 203 in FIG. 8, and it is assumed that the first time period is the time period corresponding to six subframes and the second time period is the time period corresponding to two subframes. In such a case, as shown by the hashed part 202, the amount of interference relating to the four continuous resource blocks of the first frequency band exceeds the threshold value. Therefore, the radio base station 1A transmits the interference amount information relating to the four continuous resource blocks corresponding to the hashed part 202. Furthermore, as shown by the hashed part 203, because the amount of interference relating to the eight continuous resource blocks of the second frequency band exceeds the threshold value, the radio base station 1A transmits the transmission power decrease instruction information relating to the eight continuous resource blocks corresponding to the hashed part 203. The interference amount information or the transmission power decrease instruction information relating to the other resource blocks is not transmitted.

Furthermore, in the present embodiment, before the non-periodic transmission control is performed, the radio base station 1A transmits the suspension notification information, which is the information indicating suspension of the transmission of the transmission power decrease instruction information and the interference amount information in a predetermined period, to the radio base station 1B and the radio base station 1C. Therefore, the radio base station 1B and the radio base station 1C can recognize beforehand that the transmission power decrease instruction information and the interference amount information cannot be received periodically, and can make preparations in accordance with non-periodic reception. Furthermore, when the transmission power decrease instruction information and the interference amount information cannot be received periodically, the radio base station 1B and the radio base station 1C can determine whether the cause thereof is the non-periodic transmission control in the radio base station 1A.

Furthermore, before resuming the transmission of the transmission power decrease instruction information and the interference amount information in a predetermined period, the radio base station 1A transmits the resumption notification information, which is the information indicating resumption of the transmission of the transmission power decrease instruction information and the interference amount information in a predetermined period, to the radio base station 1B and the radio base station 1C. Therefore, the radio base station 1B and the radio base station 1C can recognize beforehand that the transmission power decrease instruction information and the interference amount information can be received periodically, and can make preparations in accordance with periodic reception.

### (4) Other Embodiments

While the present invention has been described by way of the foregoing embodiments, as described above, it should not be understood that the statements and drawings forming part of this disclosure limit the invention. Further, various substitutions, examples or operational techniques shall be apparent to a person skilled in the art based on this disclosure.

In the aforementioned embodiment, a case where the radio resources used in the uplink communication from the radio terminal 2A to the radio base station 1A receive interference has been explained, but the present invention is also applicable to cases where the radio resources used in the downlink communication from the radio base station 1A to the radio terminal 2A receive interference.

Specifically, upon receipt of a radio signal from the radio base station 1A, the radio terminal 2A measures the amount of interference for each radio resource used in the communication. Additionally, the radio terminal 2A transmits the measured interference amount information to the radio base station 1A.

The measurement unit 152 within the control unit 102 of the radio base station 1A receives the interference amount information via the antenna 108 and the radio communication unit 106. The transmission processing unit 154 performs the same process as the aforementioned embodiment.

Furthermore, in the aforementioned embodiment, a case where the reciprocal of the SNR, the reciprocal of the RSSI, the BER, the PER, and the FER are used as the amount of interference is explained, however, other numeric values relating to interference can also be used as the amount of interference.

Furthermore, in the aforementioned embodiment, a radio resource in which the smallest assigned unit for a resource terminal is a resource block is explained, however, the present invention is similarly applicable even to radio resources of another structure.

Furthermore, in the aforementioned embodiment, a radio communication system in which LTE is adopted is explained, however, the present invention is applicable to any radio communication system in which communication is performed between a radio terminal and a radio base station using a radio resource.

Thus, it must be understood that the present invention includes various embodiments that are not described herein. Therefore, the present invention is limited only by the specific features of the invention in the scope of the claims reasonably evident from the disclosure above.

The entire contents of Japanese Patent Application Laid-open No. 2009-161854 (filed on Jul. 8, 2009) are incorporated in the present specification by reference.

### INDUSTRIAL APPLICABILITY

The radio base station and the communication control method according to the present invention enable appropriate communication control relating to a radio resource while reducing the communication load between radio base stations, and are useful as a radio base station and a communication control method.

1. A radio base station which performs communication by assigning a radio resource to a radio terminal, comprising:
a measurement unit configured to measure, for each radio resource, an amount of interference that the radio resource received from communication between other radio base station and other radio terminal; and
a transmission unit configured to transmit information relating to the amount of interference to other radio base station when the amount of interference measured by the measurement unit exceeds a predetermined threshold value.

2. The radio base station according to claim 1, wherein the transmission unit suspends the transmission of information relating to the amount of interference to the other radio base station when the amount of interference measured by the measurement unit is equal to or less that the predetermined threshold value.

3. The radio base station according to claim 1, wherein
the radio resource is defined based on frequency and time, and
the transmission unit transmits information for instructing to decrease the transmission power, to the other radio base station, when the amount of interference received by the radio resource of the predetermined frequency band exceeds the predetermined threshold value for a first time period or longer.

4. The radio base station according to claim 1, wherein
the radio resource is defined based on frequency and time, and
the transmission unit transmits the amount of interference to the other radio base station, when the amount of interference received by the radio resource of the predetermined frequency band exceeds the predetermined threshold value for a second time period or longer.

5. The radio base station according to claim 1, wherein
the transmission unit transmits suspension notification information indicating suspension of the transmission of the information relating to the amount of interference to the other radio base station in a predetermined period.

6. The radio base station according to claim 5, wherein the transmission unit transmits resumption notification information indicating resumption of the transmission of the information relating to the amount of interference to the other radio base station in a predetermined period, after transmitting the suspension notification information.

7. A communication control method of a radio base station in which communication is performed by assigning a radio resource to a radio terminal, comprising:
a step in which the radio base station measures for each radio resource an amount of interference that the radio resource receives from communication between other radio base station and other radio terminal; and
a step in which the radio base station transmits information relating to the amount of interference to other radio base station when the measured amount of interference exceeds a predetermined threshold value.

8. The radio base station according to claim 2, wherein
the radio resource is defined based on frequency and time, and
the transmission unit transmits information for instructing to decrease the transmission power, to the other radio base station, when the amount of interference received by the radio resource of the predetermined frequency band exceeds the predetermined threshold value for a first time period or longer.

9. The radio base station according to claim 2, wherein
the radio resource is defined based on frequency and time, and
the transmission unit transmits the amount of interference to the other radio base station, when the amount of interference received by the radio resource of the predetermined frequency band exceeds the predetermined threshold value for a second time period or longer.
